(19) United States
(12) Patent Application Publication
(10) Pub. No.: US 2012/0008465 A1
(43) Pub. Date: Jan. 12, 2012

(54) Multiple display clock

(75) Inventors: Chin-Hsuen Lin, Taipei City (TW); Mao-Ching Chao, Tainan County (TW)

(73) Assignee: Young Town Enterprises Co., Ltd.

(21) Appl. No.: 12/803,900

(22) Filed: Jul. 9, 2010

(51) Int. Cl. G04C 17/00; G04B 19/24

(52) U.S. Cl. 368/29

(57) ABSTRACT

A multiple display clock includes date and month timing units mounted on a clock body, and each including a needle, and a stepper motor to drive the needle. A controller is coupled to a digital display and the stepper motors of the date and month timing units, and includes a processor controlling a digital time counter to count a calendar time. The processor controls the digital display to display digital time information, and activates the stepper motors of the date and month timing units to drive the date and month needles for display of analog calendar time information. A main timing unit is disposed on the clock body and has a stepper motor that is used to drive minute and hour needles, and that is disconnected from the controller.

### BACKGROUND OF THE INVENTION

1. Field of the Invention

The invention relates to a multiple display clock device, more particularly, to a multiple display clock device that has a processor to control a digital display and needle indicators.

2. Description of the Related Art

Referring to FIG. 1, a conventional multiple display clock 1 has a clock face to display a calendar time including hour, minute, seconds, date, day of week, and month, and includes a main timing unit 11 to display hour, minute and seconds, and three auxiliary timing units 12, 13, 14 to display date, month and day of week, respectively.

Rotational movements of the main and auxiliary timing units 11, 12, 13 and 14 are driven by a drive mechanism that includes a single stepper motor and a gear train (not shown) composed of gears with appropriate gear ratios that are designed according to the required movement ratios of needle indicators of the main and auxiliary timing units 11, 12, 13, 14. The drive mechanism is controlled by an electronic controller and produces an initial driving movement to a second needle of the timing unit 11 so that the second needle moves one step per one second. The initial driving movement is transmitted to minute and hour needles of the timing unit 11 and thereafter to date, month, and week needles of the timing units 12, 13, 14 to display minute, hour, date, day of week, and month data on the clock face of the clock 1. Because the movements of the needles are dependent upon each other, only when the second needle is moved correctly, can the remaining needles of the timing units 11, 12, 13, 14 be advanced properly to display correct time data on the clock 1. In addition, since the gear train has to drive all of the needles of the timing unit 11, 12, 13, 14, the construction thereof is complicated, and requires considerable numbers of intermeshing gear wheels that may result in an accumulation of error tolerances that in turn can generate an inaccurate time measurement and display on the clock 1.

### SUMMARY OF THE INVENTION

An object of the present invention is to provide a multiple display clock that can measure and display a calendar time precisely compared to the conventional multiple display clock.

According to the present invention, a multiple display clock comprises a date timing unit, a month timing unit, a digital display, and a controller. The clock body has a clock face and a back side. The date timing unit is mounted on the clock body and includes a date needle disposed on the clock face, a circular array of indicia disposed around the date needle, a stepper motor to drive the date needle, and a crown manually operable to rotate the date needle. The month timing unit is mounted on the clock body and includes a month needle disposed on the clock face, a circular array of indicia disposed around the month needle, a stepper motor to drive the month needle, and a crown manually operable to rotate the month needle. The digital display is disposed on the clock body. The controller is coupled to the digital display and the stepper motors of the date and month timing units, and includes a processor and a digital time counter. The processor is operative to control the digital time counter to count a calendar time, to control the digital display based on a count result of the digital time counter to display digital time information, and to activate the stepper motor of each of the date and month timing units based on the count result of the digital time counter so that the date and month needles display analog calendar time information.

### BRIEF DESCRIPTION OF THE DRAWINGS

Other features and advantages of the present invention will become apparent in the following detailed description of the preferred embodiments with reference to the accompanying drawings, of which:

FIG. 1 shows a multiple display clock in the prior art;

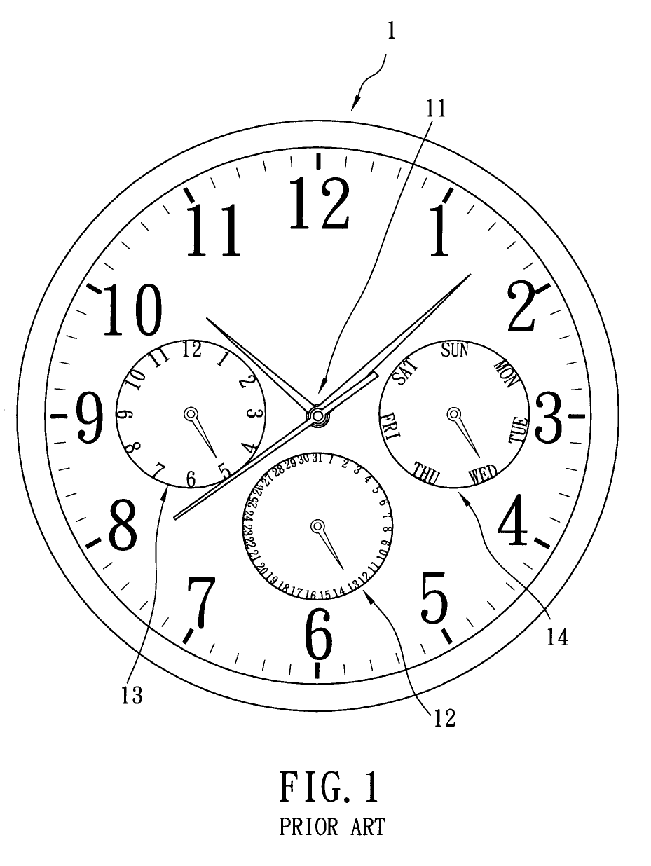

FIG. 2 is a front view of a multiple display clock according to the first preferred embodiment of the present invention;

FIG. 3 is a rear view of the multiple display clock of FIG. 2;

FIG. 4 is a block diagram illustrating the multiple display clock of FIG. 2;

FIG. 5 is a front view of a multiple display clock according to the second preferred embodiment of the present invention;

FIG. 6 is a rear view of the multiple display clock of FIG. 5; and

FIG. 7 is a front view of a multiple display clock according to the third preferred embodiment of the present invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

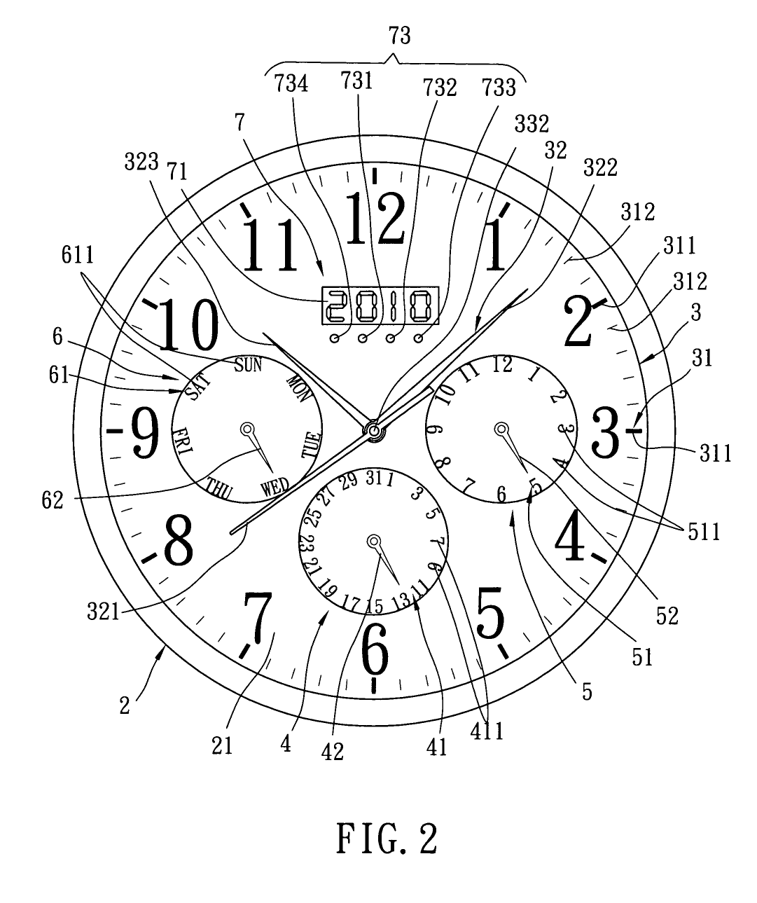

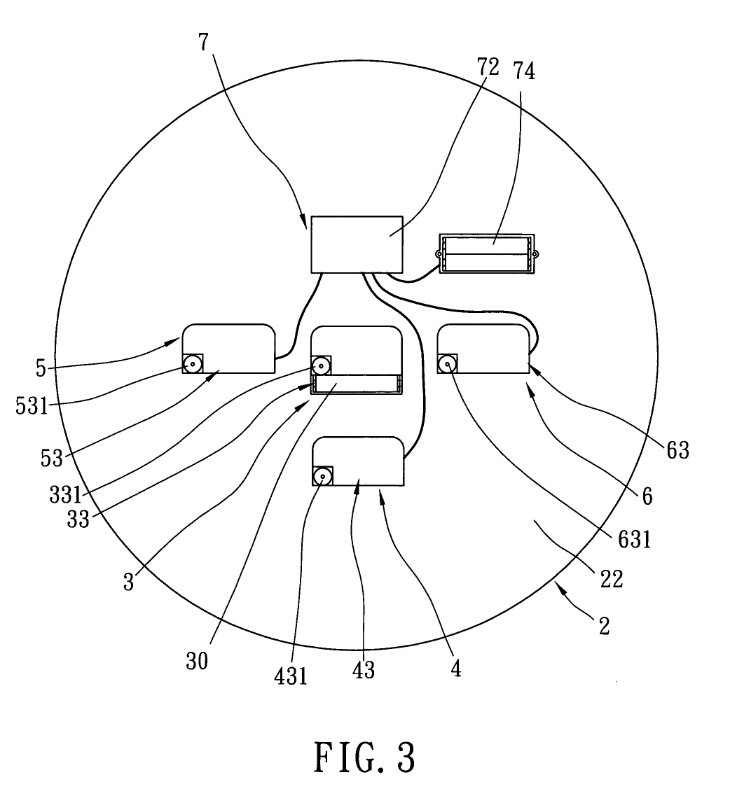

Referring to FIGS. 2 to 4, a first preferred embodiment of the multiple display clock according to the present invention includes a clock body 2, a main timing unit 3, three auxiliary timing units including a date timing unit 4, a month timing unit 5, a day of week timing unit 6, and an electronic time measuring device 7 that includes a digital display 71, a controller 72, an input unit 73, and a battery 74. The clock body 2 has a front clock face 21 and a back side 22.

The main timing unit 3 includes a battery 30, a circular array of indicia 31 disposed on the clock face 21, a needle indicator 32 disposed within a region defined by the indicia 31, and a needle drive 33 attached to the back side 22 of the clock body 2 to rotate stepwise the needle indicator 32. The indicia 31 has twelve marks 311 that are arranged in a circle in an equally spaced apart manner and that are denoted respectively by twelve numbers, such as, 1 through 12. The spacing between the marks 311 is divided into five intervals by four sub-marks.

The needle indicator 32 includes a second needle 321, a minute needle 322 and an hour needle 323. The second needle 321 travels a distance equal to the spacing of the sub-marks 312 each second. The minute needle 322 travels a distance equal to the spacing of the sub-marks 312 each minute. The hour needle 323 travels a distance equal to the spacing of the marks 311 each hour.

The needle drive 33 includes a stepper motor 332, a gear train (not shown) driven by the stepper motor 332 to rotate the needle indicator 32, and a crown 331 operable manually to adjust each of the second, minute and hour needles 321, 322, 323 to a desired display position.

The date timing unit 4 includes a circular array of indicia 41 on the clock face 21, a needle indicator or date needle 42 disposed within a region defined by the indicia 41, and a needle drive 43 attached to the back side 22 of the clock body 2 to drive stepwise the date needle 42. The indicia 41 have thirty one marks 411 that are denoted respectively by thirty one numbers, such as, 1 through 31. The date needle 42 travels one time a distance equal to the spacing between the marking numbers of the indicia 41. The needle drive 43 includes a stepper motor 432, a gear train (not shown) driven by the stepper motor 432 to rotate the date needle 42, and a crown 431 manually operable to adjust the date needle 421.

The month timing unit 5 includes a circular array of indicia 51 on the clock face 21, a needle indicator or a month needle 52, and a needle drive 53 to drive the month needle 52. The indicia 51 have twelve marks 411 denoted respectively by twelve numbers, such as, 1 through 12. Each month, the month needle 52 travels a distance equal to the spacing between the marking numbers of the indicia 41. The needle drive 53 includes a stepper motor 532, a gear train (not shown) driven by the stepper motor 532 to rotate the month needle 52, and a crown 531 operable to adjust the month needle 52.

The day of week timing unit 6 includes a circular array of indicia 61 on the clock face 21, a needle indicator or day of week needle 62, and a needle drive 63 to drive the day of week needle 62. The indicia 61 has seven marks 611 that are denoted respectively by seven names, such as, SUN, MON, TUE, etc. Each day, the day of week needle 62 travels a distance equal to the spacing between the marking numbers of the indicia 61. The needle drive 63 includes a stepper motor 632, a gear train (not shown) driven by the stepper motor 632 to rotate the day of week needle 62, and a crown 631 manually operable to adjust the day of week needle 62.

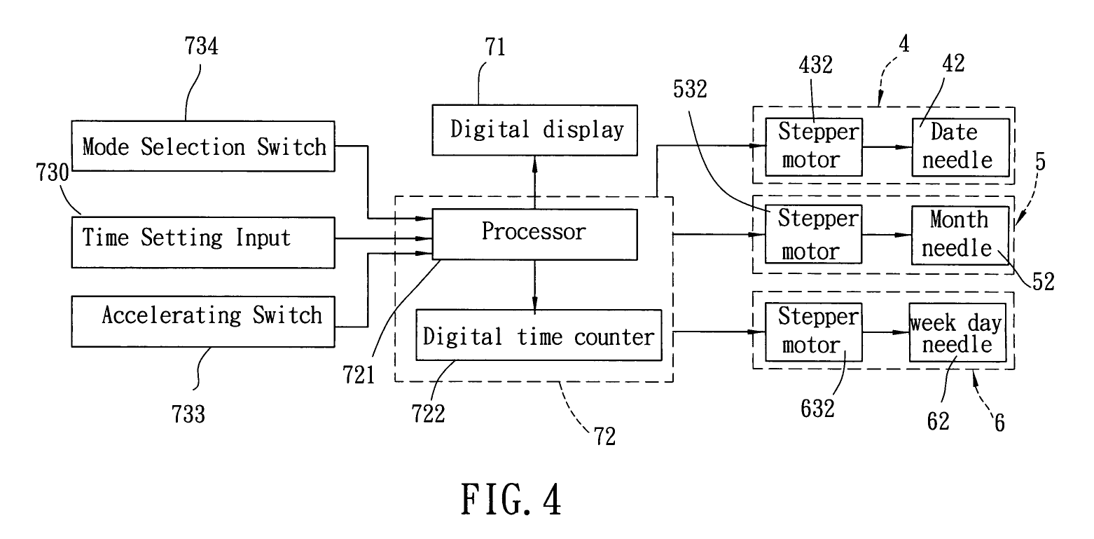

Referring back to FIGS. 2 and 4, the digital display 71 is disposed on the clock face 21 and is coupled to the controller 72. The controller 72 includes a processor 721, and a digital time counter 722. The input unit 73 is disposed on the clock face and includes a mode selection switch 734, an accelerating switch 733, and a digital input 730 that is composed of a digit increment button 731, and a digit decrement button 732. The power source 74 is disposed on the back side 22 of the clock body 2.

The processor 721 is coupled to the stepper motors 432, 532, 632 of the auxiliary timing units 4, 5, 6, but not coupled to the stepper motor of the main timing unit 3. The processor 721 includes a calendar program, and is operative to control the digital time counter 722 to count a calendar time according to the calendar program. The processor 721 further controls the digital display 71 and the stepper motors 432, 532, 632 of the auxiliary timing units 4, 5, 6 based on count results of the digital time counter 722. Accordingly, the digital display 71 displays digital calendar time information including second, minute, hour, date, day of week and month data. In addition, the date needle 42, the month needle 52, and the day of week needle 62, of the timing units 4, 5 6 display analog calendar time information including date, month, and day of week data. The main timing unit 3 operates independently of the auxiliary timing units 4, 5, 6 and the processor 721. The second, minute and hour needles 321, 322, 323 of the main timing unit 3 are operated in a conventional manner by means of the battery 30 and the stepper motor (not shown) of the main timing unit 3.

The digital calendar information includes year, month, day of week, date, hour, minute and second data. The processor 721 can recognize a leap year within a prescribed range of years, for instance, within the years from 2000 to 2099, or determines whether or not the year displayed in the digital display 71 is a leap year. The processor 721 can also recognize or determine the number of days in each month of the prescribed year. If the prescribed year is determined to be a leap year, some months have 30 days, some months have 31 days, and February has 29 days. If the prescribed year is a non-leap year, some months have 30 days, some months have 31 days, and February has 28 days.

The mode selection switch 734 is manually operable to generate a switching signal to the processor 732 for switching the processor 721 between a time setting mode and a normal operating mode. The digit increment button 731 and the digit decrement button 732 of the time setting input 730 are manually operable to generate digital time input signals to said processor when said processor is in the time setting mode. The accelerating switch 733 is manually operable to generate an acceleration control signal to said processor when the processor is in the time setting mode.

The processor 721 controls display by the digital display 71 of the current year, month, date, day of week, hour, seconds and minute. In a normal state, only the current year, for example, “2010” is displayed on the digital display 71. The processor 721 is operative to generate a series of signals to activate the stepper motors 432, 532, 632 of the auxiliary timing units 4, 5, 6 so that the date, month and day of week needles 42, 52 and 62 are driven to rotate at their respective rotation rates. Specifically, the date needle 421 rotates 1/31 revolution per day, the month needle 521 rotates 1/12 revolution per month, and the day of week needle 621 rotates 1/7 revolution per day.

At every midnight 00:00 (PM12:00), the processor 721 generates signals to simultaneously move the date and day of week needles 42 and 62 so that the date needle 42 moves a distance of 1/31 revolution or an angle of 360°/31 from the current date to the next date and so that the day of week needle 62 moves a distance of 1/7 revolution or an angle of 360°/7 from the current day of week to the next day of week. The date needle 42 and the day of week needle 62 are therefore advanced one day.

At midnight 00:00 (12:00 AM) of the last day of each month, the processor 721 generate signals to simultaneously activate the stepper motors 432, 532, 632 so that the date needle 42 moves to the next date, the day of week needle 62 moves to the next day of week, and the month needle 52 moves to the next month. The distance that the date needle 42 moves is dependent on how many days the current month has.

If the current month has 28 days, at midnight of the 28^{th} day of the current month, the processor 721 generates a signal to move the date needle 42 four steps one time so that the date needle 42 moves from the current date of “28” to the next date of “1” of the next month.

If the current month has 29 days, at midnight of the 29^{th} day of the current month, the processor 721 generates a signal to rotate the date needle 42 three steps one time so that the date needle 42 moves from the current date of “29” to the next date of “1” of the next month.

If the current month has 30 days, at midnight of the 30^{th} day of the current month, the processor 721 generates a signal to move the date needle 42 two steps one time so that the date needle 42 moves from the current date of “30” to the next date of “1” of the next month.

If the current month has 31 days, at midnight of the 31st day of the current month, the central processor 72 generates a signal to move the date needle 42 one step one time so that the date needle 42 moves from the current date of “31” to the next date of “1” of the next month.

If it is desired to examine whether or not the multiple display clock measures a calendar time correctly, a clock test may be conducted by pressing the mode selection switch 734 to switch the processor 721 to a time setting mode. When the processor 721 is in the time setting mode, the accelerating switch 734 is pressed so that the processor 721 controls the digital time counter 722 to count the calendar time at a rapid count rate that is faster than a normal count rate. The rapid count rate may be ten times the normal count rate, or less than or larger than ten times the normal count rate. For example, at a rapid count rate, the digital display may increment the displayed time by one second for each 0.1 second that passes. Based on the count results of the digital time counter 722 produced at the rapid count rate, the processor 721 generates control signals to the digital display 71 so that constantly changing digital calendar data are displayed at a rapid date. Based on the count results, the processor 721 also generates control signals to increase the stepping rates of the stepper motors 432, 532, 632 so that the date, month and day of week needles 42, 52, 62 moves rapidly. By watching the changing digital calendar data displayed on the digital display 71, and the stepping movements of the date, month and day of week needles 42, 52, 62, an operator can determine whether the multiple display clock measures the calendar time correctly. If an invalid date is displayed by the digital display 71, and/or the date, month, and/or day of week needles 42, 52, 62, the time measurement in the multiple display clock should be considered to be incorrect. Because the count rate of the digital time counter 72 is increased, the clock test may be conducted within a short time.

When the battery 74 of the controller 72 and/or the battery 30 of the main timing unit 3 are exhausted, the time measuring operations of the main timing unit 3 and the auxiliary timing units 4, 5 and 6 become asynchronous. In this case, after a change of the batteries 74 and/or 30, the crowns 331, 431, 531, and/or 631 of the auxiliary timing units 4, 5, 6 may be operated manually to rotate the second, minute and hour needles 321, 322, 323 of the main timing unit 3 and/or the date, month and/or day of week needles 42, 52, 62 and to indicate the current time, date, month and day of week.

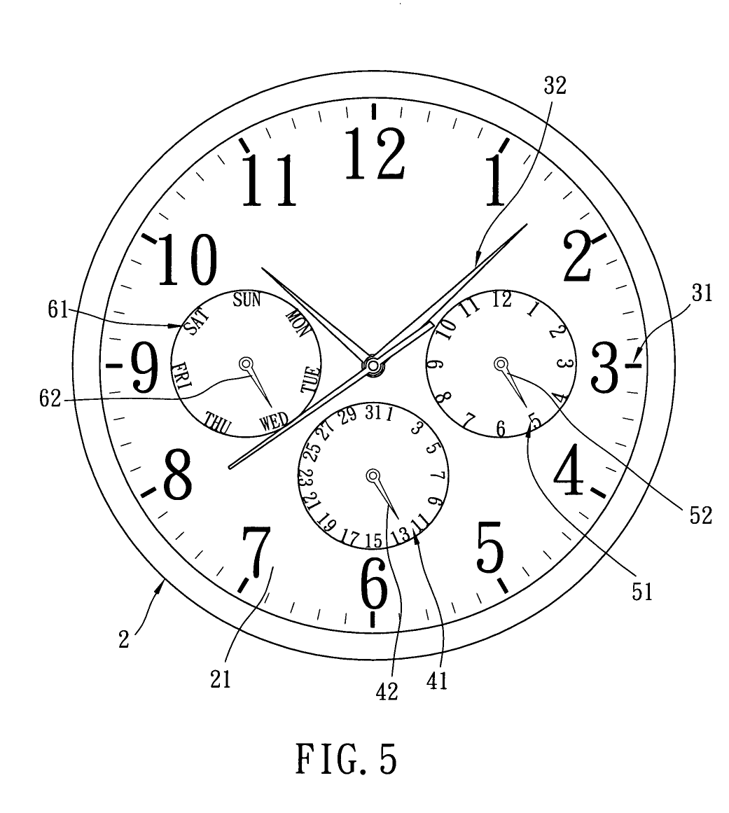

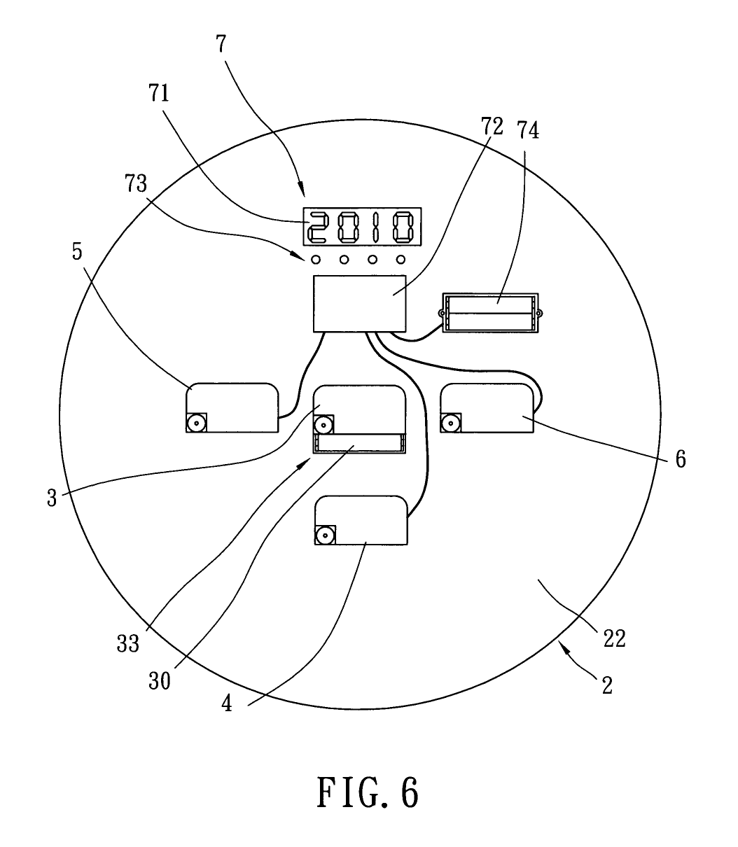

Referring to FIGS. 5 and 6, the second preferred embodiment of the multiple display clock according to the present invention is substantially similar to the first preferred embodiment except that the digital display 71 and the input unit 73 are disposed on the back side 22 of the clock body 2. Therefore, the digital display 71 cannot be seen on the clock face 21 of the clock body 2.

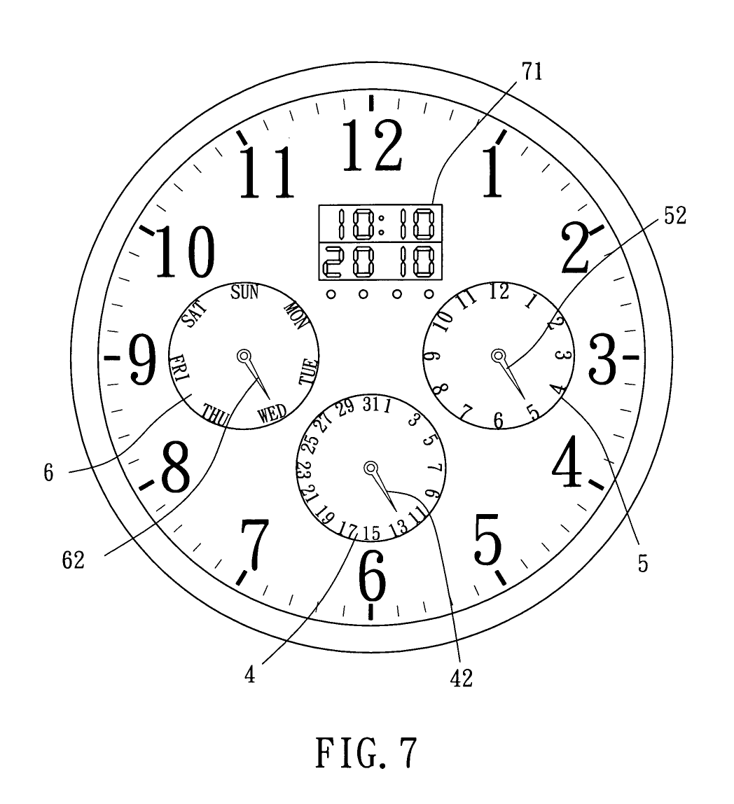

Referring to FIG. 7, the third preferred embodiment of the multiple display clock according to the present invention is substantially similar to the first preferred embodiment except that the second, minute and hour needles 321, 322, 323 of the main timing unit 3 are eliminated in the third preferred embodiment. The digital display 71 serves to display minute and hour data.

According to the present invention, the date, month and day of week needles 42, 52, 62 are driven by the respective stepper motors 432, 532 and 632 through respective gear trains (not shown), and the stepper motors 432, 532, 632 are connected to the processor 721 using wires. The second, minute and hour needles 321, 322, 323 are driven by an individual stepper motor (not shown) of the main timing unit 3. Because the processor 721 controls the individual stepper motors 432, 532, 632 to drive the date, month, day of week needles, 42, 52, 62, respectively, analog date, month and day of week data can be displayed accurately by the date, month and day of week needles 42, 52, 62. In addition, the present invention dispenses with a complicated gear train that is used conventionally to drive simultaneously all of needles for displaying second, minute, hour, date, day of week, and month data. The gear trains used in the main and auxiliary timing units, 3, 4, 5 6 can be provided with a simplified construction and need not be interconnected each other.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A multiple-display clock comprising:
a clock body having a clock face and a back side;
a date timing unit mounted on said clock body and including a date needle disposed on said clock face, a circular array of indicia disposed around said date needle, a stepper motor to drive said date needle, and a crown manually operable to rotate said date needle;
a month timing unit mounted on said clock body and including a month needle disposed on said clock face, a circular array of indicia disposed around said month needle, a stepper motor to drive said month needle, and a crown manually operable to rotate said month needle;
a digital display disposed on said clock body; and
a controller coupled to said digital display and said stepper motors of said date and month timing units, and including a processor and a digital time counter, said processor being operative to control said digital time counter to count a calendar time, to control said digital display based a count result of said digital time counter to display digital time information, and to activate said stepper motor of each of said date and month timing units based on the count result of said digital time counter so that said date and month needles display analog calendar time information.

2. The multiple display clock of claim 1, further comprising a main timing unit that has at least hour and minute needles, a circular array of indicia disposed on said clock face around said hour and minute needles, a stepper motor to rotate said hour and minute needles, and a crown manually operable to adjust each of said hour and minute needles to a desired position of said indicia of said main timing unit, wherein said stepper motor of said main timing unit is disconnected from said controller.

3. The multiple display clock of claim 2, further comprising a day of week timing unit that includes a day of week needle disposed on said clock face, a circular array of indicia disposed around said day of week needle, a stepper motor to drive said day of week needle, and a crown manually operable to rotate said day of week needle, said processor being coupled to said stepper motor of said day of week timing unit.

4. The multiple display clock of claim 1, wherein said digital display is disposed on said clock face of said clock body.

5. The multiple display clock of claim 1, wherein said digital display is disposed on said back side of said clock body.

6. The multiple display clock of claim 1, further comprising a mode selection switch coupled to said processor and manually operable to generate a switching signal to said processor such that said processor is switched between a time setting mode and a normal operating mode, a time setting input coupled to said processor and manually operable to generate digital time input signals to said processor when said processor is in the time setting mode, and an accelerating switch coupled to said processor and manually operable to generate an acceleration control signal to said processor when said processor is in the time setting mode, said processor controlling said digital time counter to count the calendar time at a rapid count rate that is faster than a normal count rate upon receipt of said acceleration control signal.
